(19) United States
(12) Patent Application Publication
(10) Pub. No.: US 2026/0310747 A1
(43) Pub. Date: Oct. 8, 2026

(54) USING INODE BITS TO IDENTIFY AN ORDER TO PERFORM ASYMMETRY OPERATIONS

(71) Applicant: International Business Machines Corporation, Armonk, NY (US)

(72) Inventors: Khanh Vi Ngo, Tucson, AZ (US); Sandeep Ramesh Patil, Pune (IN); Sasikanth Eda, Vijayawada (IN); Yadavendra Yadav, Bangalore (IN)

(21) Appl. No.: 19/173,531

(22) Filed: Apr. 8, 2025

(51) Int. Cl. G06F 17/16

(52) U.S. Cl. CPC G06F 17/16

(57) ABSTRACT

A method, according to one embodiment, comprises vectorizing data on a first site and a second site, the vectorizing comprising converting the data into numerical vectors associated with the first site and numerical vectors associated with the second site. The method further comprises comparing numerical vector pairs, where the numerical vector pairs include the numerical vectors associated with the first site and the numerical vectors associated with the second site. The method further comprises determining similarity scores for the numerical vector pairs based on the comparisons, causing inode bits for the numerical vector pairs to hold states based on the similarity scores, and using the states of the inode bits to identify an order to perform asymmetry operations of a queue associated with the first site and the second site.

### BACKGROUND

The present invention relates to data storage, and more specifically, this invention relates to data storage in a multi-site data storage system.

Some data storage systems are deployed across multiple sites. For context, a site may be defined as the location at which information technology (IT) infrastructure for offering applications and services is located at. For example, in some use cases, a server at a first site is used to store user data associated with a first application, while a server at a second site is used to store a copy of the user data that is relied on during failure events experienced by the first site. In order to ensure that the copy of the user data remains up to date, changes, e.g., writes, deletes, etc., made to the user data at the first site are mirrored on the copy of the user data at the second site.

### SUMMARY

A method, according to one embodiment, comprises vectorizing data on a first site and a second site, the vectorizing comprising converting the data into numerical vectors associated with the first site and numerical vectors associated with the second site. The method further comprises comparing numerical vector pairs, where the numerical vector pairs include the numerical vectors associated with the first site and the numerical vectors associated with the second site. The method further comprises determining similarity scores for the numerical vector pairs based on the comparisons, causing inode bits for the numerical vector pairs to hold states based on the similarity scores, and using the states of the inode bits to identify an order to perform asymmetry operations of a queue associated with the first site and the second site.

A computer program product, according to one embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using inode bits to identify an order to perform asymmetry operations.

In one general embodiment, a method comprises vectorizing data on a first site and a second site, the vectorizing comprising converting the data into numerical vectors associated with the first site and numerical vectors associated with the second site. The method further comprises comparing numerical vector pairs, where the numerical vector pairs include the numerical vectors associated with the first site and the numerical vectors associated with the second site. The method further comprises determining similarity scores for the numerical vector pairs based on the comparisons, causing inode bits for the numerical vector pairs to hold states based on the similarity scores, and using the states of the inode bits to identify an order to perform asymmetry operations of a queue associated with the first site and the second site.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as of asymmetric operation determination code of block 150 for using inode bits to identify an order to perform asymmetry operations. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

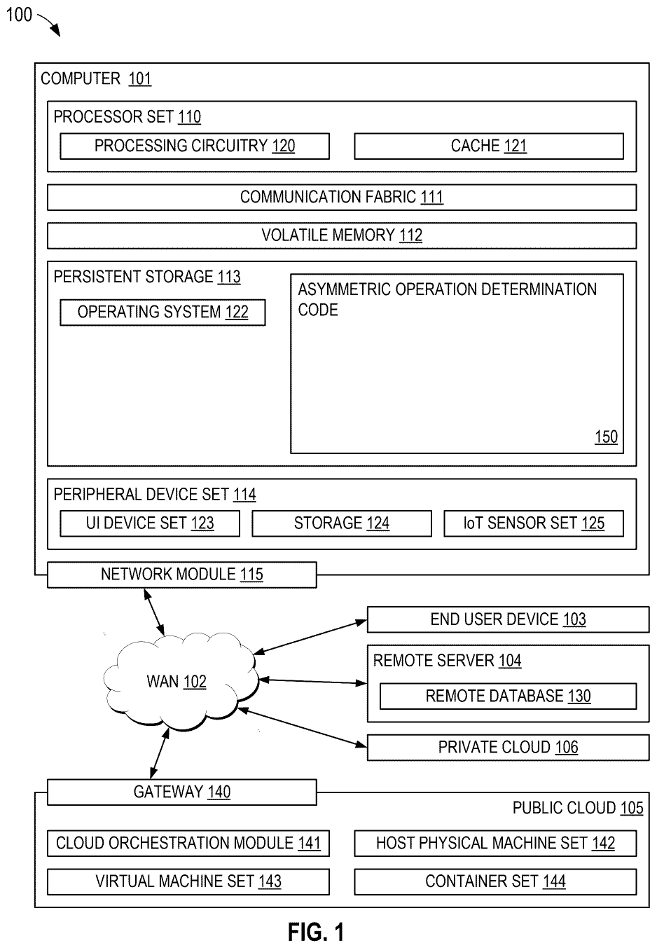

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 Is Any Type of Volatile Memory Now Known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (eud) 103 Is Any Computer System That Is Used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

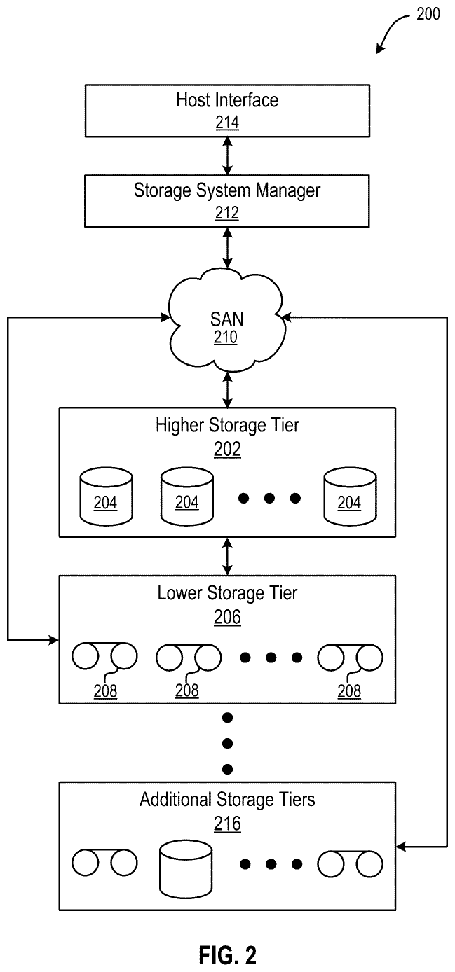

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, some data storage systems are deployed across multiple sites. For context, a site may be defined as the location at which information technology (IT) infrastructure for offering applications and services is located at. For example, in some use cases, a server at a first site is used to store user data associated with a first application, while a server at a second site is used to store a copy of the user data that is relied on during failure events experienced by the first site. In order to ensure that the copy of the user data remains up to date, changes, e.g., writes, deletes, etc., made to the user data at the first site are mirrored on the copy of the user data at the second site.

While operating within a multi-site data storage environment, incoming data may contain duplicate data which may not incorporate any value add to associated multiple secondary sites, as the secondary site may already contain vectors corresponding to the same context. Alternatively, a training phase at a secondary site may have already made use of this data, and therefore movement of the data may amount to wasted computer resources and thereby incorporate unnecessary latency into the data storage environment. Furthermore, a lack of prioritization may lead to relatively slow replay of major content and/or context change as a queue used to move and/or replicate data between sites may be filled with incremental or irrelevant changes to the data.

In order to mitigate the deficiencies described above, the techniques of embodiments and approaches described herein include using an inode to set a dirty bit that is based on the vector differences between different data sites. Depending on the approach, these vector differences may be specific to a predetermined size, e.g., correspond to a file, block, chunk, etc. Furthermore, in some of these techniques, the inode dirty bit setting may be a group of flags, which may be XOR based in order to extend the use case of these techniques. For example, the XOR combination “111” may be used to denote a significant difference between the vectors, whereas the XOR combination “001” may be used to represent that the difference between the vectors is determined to be relatively low, e.g., less than a predetermined threshold degree of difference. These dirty bit mappings may be used to determine how to manage data (or copies thereof) between different sites, e.g., optimize coalescing algorithms, change priorities, whether to replay data operations performed at a first site to secondary sites, etc.

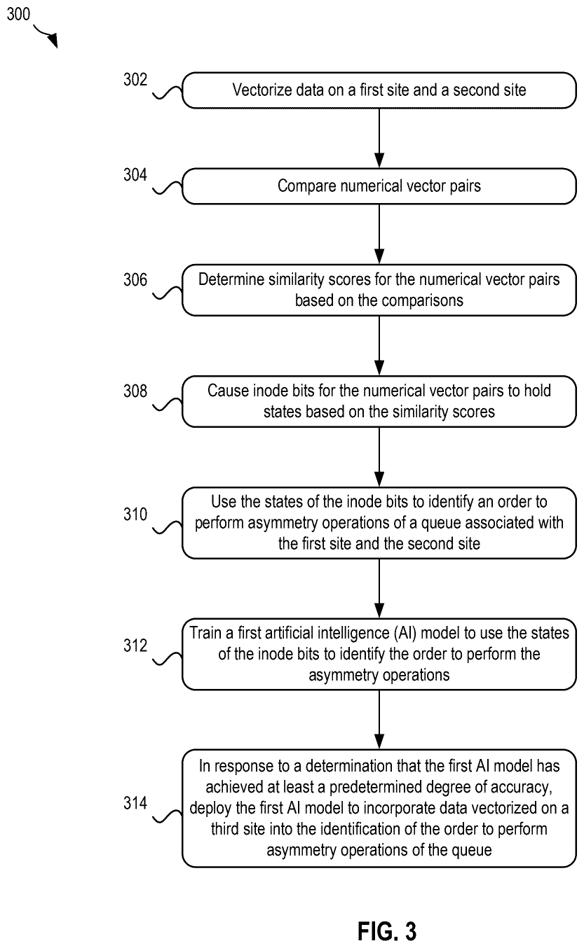

Now referring to FIG. 3, a flowchart of a method 300 is shown according to one embodiment. The method 300 may be performed in accordance with aspects of the present invention in any of the environments depicted in FIGS. 1-3, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

The operations of method 300 may be performed in any type of data storage system that includes multiple sites. In some approaches, the techniques of method 300 may be performed in a data storage system that includes a scalable file system caching layer, such as Active File Management (AFM) by INTERNATIONAL BUSINESS MACHINES CORPORATION (IBM). Accordingly, in some use cases, the operations of method 300 enable AFM gateway queue optimization using information asymmetry across sites.

In some approaches, a data mover is used to reflect data changes between the sites in this multi-site data storage system. For example, in one or more of such approaches, an in-memory queue may be filled with the change list of blocks on a primary site on order to cause changes to be replicated to a secondary site. Queue optimizations and/or coalesce algorithms used in such approaches may focus on block operations, e.g., discard all queued operations for a particular block in response to a determination that a delete is performed. This serves as a simple replay to configured secondary sites based on the dirty flag. However, as will be described in greater detail elsewhere below, the operations of method 300 furthermore incorporate efficiencies into the data storage system by offering prioritization among the blocks of the sites during any replays performed.

Various operations of method 300 may be performed with respect to a plurality of sites. For example, several operations described below are performed with respect to a first site and a second site. However, in some further approaches, these operations may be modified to be performed with respect to more than two sites, e.g., a third site, a fourth site, etc. The state and/or detail of the data at these different sites may depend on the approach and may differ from site to site. For example, in some approaches, the first site may be a host site for an application. In such an approach, the host site may enable the application to be used to modify, e.g., write to, delete, etc., data, where a copy of the data is maintained on another site, e.g., mirroring. For example, in some approaches, the second site may be a replication site for the data, where actions performed on the data on the first site are queued to be also performed on a copy of the data stored on the second site. In some approaches, a third site may store the data in a training set of data used to train AI models (artificial intelligence models), which may include AI models described herein, e.g., see the first AI model of operation 312. Accordingly, the third site may, in some approaches, be a passive site.

Operation 302 includes vectorizing data on a first site and a second site. In some approaches, the vectorizing comprises converting the data into numerical vectors associated with the first site and numerical vectors associated with the second site. In one or more of such approaches, the data may be textual data, and therefore textual analysis techniques of a type that would become apparent to one of ordinary skill in the art may be used in the process of the vectorizing.

The vectorization process may vectorize the data according to a predetermined size, in some approaches. The predetermined size may depend on the use case and/or storage infrastructure associated with the data. For example, in some approaches, the vectorizing is based on a chunk size of the data on the first site and the second site. In some other approaches, the vectorizing may be performed based on a block size of the data on the first site and the second site. In yet some further approaches, the vectorizing is based on a chunk size of the data on the first site and the second site.

It should be noted that a result of the vectorization, in some approaches, includes vectors associated with the first site and different vectors associated with the second site. At least some of the vectors associated with the first site may be paired with at least some of the vectors associated with the second site to establish vector pairs, e.g., a first vector associated with the first site and a first vector associated with the second site establish a first numerical vector pair, a second vector associated with the first site and a second vector associated with the second site establish a second numerical vector pair, etc.

Operation 304 includes comparing numerical vector pairs, where the numerical vector pairs include at least a portion of the numerical vectors associated with the first site and at least a portion of the numerical vectors associated with the second site. More specifically, in some approaches, the vectors within each pairing are compared with one another to determine a degree of similarity of the vectors. For context, differences in the vectors of a given pairing may be caused by changes being made to the data (portions of the data specifically reflected in the vector pair) on one of the sites, where the changes are not yet reflected on associated data of the other site (e.g., mirroring operations have been queued but not yet performed).

The comparing the numerical vector pairs, in some approaches, comprises using an artificial intelligence (AI) based model to perform the comparing. For example, in one or more of such approaches, the comparing the numerical vector pairs comprises instructing a trained large language model (LLM) to analyze the numerical vector pairs. In some approaches, this instruction may command the trained LLM to consume the vector pairs from snapshots performed of the different sites.

Similarity scores are determined for the numerical vector pairs based on the comparisons, e.g., see operation 306. Similarity scores, in some approaches, provide a numerical degree of similarity, e.g., a score within a predetermined range. In some other approaches, the similarity scores additionally and/or alternatively provide a textual description that summarizes determined relative degrees of similarity between the different numerical vector pairs. For approaches in which an LLM is used to perform the comparing, an output of the trained LLM may include the similarity scores.

Operation 308 includes causing inode bits for the numerical vector pairs to hold states based on the similarity scores. For context, the inode bits may serve as dirty bits that are a data structure that stores metadata about a file or directory (the chunk, file, etc. is able to be marked accordingly to different levels of change indicated by the similarity scores). For example, a first state of the inode bits (e.g., 001) may be associated with a first range of values that includes a first similarity score, while a second state of the inode bits (e.g., 111) may be associated with a second range of values that includes a second similarity score. In some approaches, the first range of values may be associated with similarity scores that indicate a relatively insignificant (relatively low) difference between the vectors of the vector pair that the similarity score is based on. In some other approaches, the second range of values may be associated with similarity scores that indicate a relatively significant (relatively high) difference between the vectors of the vector pair that the similarity score is based on. These different potential states are described in greater detail below.

In some approaches, a first of the states of a first of the inode bits (e.g., 001) for a first of the numerical vector pairs may have a first of the determined similarity scores that represents a first chunk of the data on the first site not having more than a predetermined threshold degree of similarity with a second chunk of the data on the second site. In contrast, a second of the states (111) of the first inode bit may represent the first chunk of the data on the first site having more than the predetermined threshold degree of similarity with the second chunk of the data on the second site. In another example, a first of the states (001) of a second of the inode bits for a second of the numerical vector pairs may have a second of the determined similarity scores represents a third chunk of the data on the first site not having more than the predetermined threshold degree of similarity with a fourth chunk of the data on the second site, while a second of the states (111) of the second inode bit may represent the third chunk of the data on the first site not having more than the predetermined threshold degree of similarity with the fourth chunk of the data on the second site.

These inode bits enable file and/or blocks and/or chunks to be dynamically marked as dirty based on the vector differences between the sites or site to application (as the differences between the sites are determined to change over time). It should be noted that these differences, if gone unnoticed, would otherwise cause drift in states of the data at the different sites. This drift results in inaccuracies, stalling, and wasted processing resources when the data of a given site is used without the understanding that the data does not reflect an accurate state of the data, e.g., where asymmetric data operations are queued but not yet performed. Accordingly, the techniques described herein preserve processing resources of infrastructure that analyzes and uses the data of the difference sites.

Operation 310 includes using the states of the inode bits to identify an order to perform asymmetry operations of a queue associated with the first site and the second site. For context, the queue associated with the first site and the second site may queue a plurality of asymmetry operations as the asymmetry operations are created. These asymmetry operations may be created as different events result in changes to data on one of the sites that is to be reflected on another of the sites. For example, within the queue, in some approaches, a first of the asymmetry operations may be for at least some of the data vectorized into the first numerical vector pair, while a second of the asymmetry operations may be for at least some of the data vectorized into the second numerical vector pair.

With continued reference to the examples of the different states of the inode bits described elsewhere above, in some approaches, the using the states of the inode bits to identify the order to perform the asymmetry operations comprises identifying inode bits associated with a relatively greatest degree of difference. For example, in response to a determination that the first inode bits hold the first state of the first inode bits and the second inode bits hold the second state of the second inode bits, the first asymmetry operation is ordered to be performed before the second asymmetry operation. In other words, while using the different states of the inode bits to determine an ordering of the asymmetric operations, inode bits that represent relatively greater differences between the data of the sites are prioritized over inode bits that represent relatively lesser differences between the data of the sites. This way, states of data between different sites that are relatively furthest from an accurate state are corrected relatively sooner than other states of data that are relatively less different from one another. Accordingly, in some approaches, the asymmetric operations may include performing writes, reads, deletes, etc., to change the state of the data on one or more of the sites.

In some other approaches, the asymmetric operations may additionally and/or alternatively include coalescing gateway queue operations based on the marked file.

In some approaches, replay(s) to sites (the performing of an asymmetric operation on a site that has already been performed on a different site) may additionally and/or alternatively be prioritized based on weights assigned to the vectors. For example, in some approaches, different weights (which may be dynamically adjustable) may be assigned to the different numerical vector pairs. In some approaches, these different weights are initially each a default value that is dynamically adjusted based on determined frequency of use statistics associated with the data of the vectors. Method 300, in some approaches, includes using the different weights to identify the order to perform the asymmetry operations.

It should be noted that as the vectors change over time, the similarity scores for the numerical vector pair comparisons can be expected to also change over time. Accordingly, in response to a determination that the similarity scores for a first portion of the numerical vector pairs have been updated based on updated comparisons, the inode dirty bits for the first portion of the numerical vector pairs may be caused to hold updated states based on the updated similarity scores.

Operation 312 includes training a first AI model to use the states of the inode bits to identify the order to perform the asymmetry operations. Initial training of the first AI model may include reward feedback that may, in some approaches, be implemented using a subject matter expert (SME) that generally understands whether the AI model is able to successfully determine proven orderings. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the first AI model is trained and ready to deploy for performing techniques and/or operations of method 300 may be performed. For example, in response to a determination that the first AI model has achieved at least a predetermined degree of accuracy, the first AI model is deployed to incorporate data vectorized on a third site into the identification of the order to perform the asymmetry operations of the queue, e.g., see operation 314. In other words, the trained AI model may be used to scale out the operations described herein to be performed with respect to data of three or more sites.

In some further approaches, the AI model may be a neuromyotonic AI model that may improve performance of computer devices in an infrastructure associated with the data storage environment described herein, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from feedback looks, e.g., similar to the dynamic weights described elsewhere herein.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
vectorizing data on a first site and a second site, the vectorizing comprising converting the data into numerical vectors associated with the first site and numerical vectors associated with the second site;
comparing numerical vector pairs, wherein the numerical vector pairs include the numerical vectors associated with the first site and the numerical vectors associated with the second site;
determining similarity scores for the numerical vector pairs based on the comparisons;
causing inode bits for the numerical vector pairs to hold states based on the similarity scores; and
using the states of the inode bits to identify an order to perform asymmetry operations of a queue associated with the first site and the second site.

2. The method of claim 1, wherein the vectorizing is based on a chunk size of the data on the first site and the second site.

3. The method of claim 1, wherein the comparing the numerical vector pairs comprises: instructing a trained large language model (LLM) to analyze the numerical vector pairs, wherein an output of the LLM includes the similarity scores.

4. The method of claim 1, wherein a first of the states of a first of the inode bits for a first of the numerical vector pairs having a first of the determined similarity scores represents a first chunk of the data on the first site not having more than a predetermined threshold degree of similarity with a second chunk of the data on the second site, wherein a second of the states of the first inode bit represents the first chunk of the data on the first site having more than the predetermined threshold degree of similarity with the second chunk of the data on the second site, wherein a first of the states of a second of the inode bits for a second of the numerical vector pairs having a second of the determined similarity scores represents a third chunk of the data on the first site not having more than the predetermined threshold degree of similarity with a fourth chunk of the data on the second site, wherein a second of the states of the second inode bit represents the third chunk of the data on the first site not having more than the predetermined threshold degree of similarity with the fourth chunk of the data on the second site.

5. The method of claim 4, wherein a first of the asymmetry operations is for the data vectorized into the first numerical vector pair, wherein a second of the asymmetry operations is for the data vectorized into the second numerical vector pair, wherein the using the states of the inode bits to identify the order to perform asymmetry operations comprises:
in response to a determination that the first inode bits hold the first state of the first inode bits and the second inode bits hold the second state of the second inode bits, ordering the first asymmetry operation to be performed before the second asymmetry operation.

6. The method of claim 1, wherein different weights are assigned to the different numerical vector pairs, and further comprising: using the weights to identify the order to perform asymmetry operations.

7. The method of claim 1, further comprising:
training a first artificial intelligence (AI) model to use the states of the inode bits to identify the order to perform the asymmetry operations; and
in response to a determination that the first AI model has achieved at least a predetermined degree of accuracy, deploying the first AI model to incorporate data vectorized on a third site into the identification of the order to perform the asymmetry operations of the queue.

8. The method of claim 7, wherein the first site is a host site for an application, wherein the second site is a replication site for the data, wherein the third site stores the data in a training set of data used to train AI models including the first AI model.

9. The method of claim 1, further comprising:
in response to a determination that the similarity scores for a first portion of the numerical vector pairs have been updated based on updated comparisons, causing the inode bits for the first portion of the numerical vector pairs to hold updated states based on the updated similarity scores.

10. A computer program product comprising:
one or more computer-readable storage media; and
program instructions stored on the one or more storage media to perform operations comprising:
vectorizing data on a first site and a second site, the vectorizing comprising converting the data into numerical vectors associated with the first site and numerical vectors associated with the second site;
comparing numerical vector pairs, wherein the numerical vector pairs include the numerical vectors associated with the first site and the numerical vectors associated with the second site;
determining similarity scores for the numerical vector pairs based on the comparisons;
causing inode bits for the numerical vector pairs to hold states based on the similarity scores; and
using the states of the inode bits to identify an order to perform asymmetry operations of a queue associated with the first site and the second site.

11. The computer program product of claim 10, wherein the vectorizing is based on a chunk size of the data on the first site and the second site.

12. The computer program product of claim 10, wherein the comparing the numerical vector pairs comprises: instructing a trained large language model (LLM) to analyze the numerical vector pairs, wherein an output of the LLM includes the similarity scores.

13. The computer program product of claim 10, wherein a first of the states of a first of the inode bits for a first of the numerical vector pairs having a first of the determined similarity scores represents a first chunk of the data on the first site not having more than a predetermined threshold degree of similarity with a second chunk of the data on the second site, wherein a second of the states of the first inode bit represents the first chunk of the data on the first site having more than the predetermined threshold degree of similarity with the second chunk of the data on the second site, wherein a first of the states of a second of the inode bits for a second of the numerical vector pairs having a second of the determined similarity scores represents a third chunk of the data on the first site not having more than the predetermined threshold degree of similarity with a fourth chunk of the data on the second site, wherein a second of the states of the second inode bit represents the third chunk of the data on the first site not having more than the predetermined threshold degree of similarity with the fourth chunk of the data on the second site.

14. The computer program product of claim 13, wherein a first of the asymmetry operations is for the data vectorized into the first numerical vector pair, wherein a second of the asymmetry operations is for the data vectorized into the second numerical vector pair, wherein the using the states of the inode bits to identify the order to perform the asymmetry operations comprises:
in response to a determination that the first inode bits hold the first state of the first inode bits and the second inode bits hold the second state of the second inode bits,
ordering the first asymmetry operation to be performed before the second asymmetry operation.

15. The computer program product of claim 10, wherein different weights are assigned to the different numerical vector pairs, and further comprising: using the weights to identify the order to perform the asymmetry operations.

16. The computer program product of claim 10, wherein the operations further comprise:
training a first artificial intelligence (AI) model to use the states of the inode bits to identify the order to perform the asymmetry operations; and
in response to a determination that the first AI model has achieved at least a predetermined degree of accuracy, deploying the first AI model to incorporate data vectorized on a third site into the identification of the order to perform the asymmetry operations of the queue.

17. The computer program product of claim 16, wherein the first site is a host site for an application, wherein the second site is a replication site for the data, wherein the third site stores the data in a training set of data used to train AI models including the first AI model.

18. The computer program product of claim 10, wherein the operations further comprise:
in response to a determination that the similarity scores for a first portion of the numerical vector pairs have been updated based on updated comparisons, causing the inode bits for the first portion of the numerical vector pairs to hold updated states based on the updated similarity scores.

19. A computer system comprising:
a processor set;
one or more computer-readable storage media; and
program instructions stored on the one or more storage media to cause the processor set to perform operations comprising:
vectorizing data on a first site and a second site, the vectorizing comprising converting the data into numerical vectors associated with the first site and numerical vectors associated with the second site;
comparing numerical vector pairs, wherein the numerical vector pairs include the numerical vectors associated with the first site and the numerical vectors associated with the second site;
determining similarity scores for the numerical vector pairs based on the comparisons;
causing inode bits for the numerical vector pairs to hold states based on the similarity scores; and
using the states of the inode bits to identify an order to perform asymmetry operations of a queue associated with the first site and the second site.

20. The computer system of claim 19, wherein the vectorizing is based on a chunk size of the data on the first site and the second site.
